(19) United States
(12) Patent Application Publication
(10) Pub. No.: US 2025/0166244 A1
(43) Pub. Date: May 22, 2025

(54) METHOD AND APPARATUS FOR PROCESSING EFFECT IMAGE, ELECTRONIC DEVICE, AND STORAGE MEDIUM

(71) Applicant: Lemon Inc., Grand Cayman (KY)

(72) Inventors: Xu CHEN, Beijing (CN); Yahan LIANG, Beijing (CN); Siyao YANG, Los Angeles, CA (US)

(21) Appl. No.: 18/832,857

(22) PCT Filed: Jan. 11, 2023
(86) PCT No.: PCT/SG2023/050019

§ 371 Date: Jul. 24, 2024

(30) Foreign Application Priority Data
Jan. 24, 2022 (CN) 202210080899.7

(51) Int. Cl. G06T 11/00; G06T 11/20

(52) U.S. Cl. CPC G06T 11/001; G06T 11/203; G06T 2200/24

(57) ABSTRACT

Provided in the embodiments of the present disclosure are a method and apparatus for processing an effect image, and an electronic device and a storage medium. The method comprises: obtaining an image to be processed; determining a brush model to be rendered that corresponds to the image to be processed; and rendering, according to a drawing parameter, a line to be rendered in the brush model to be rendered, and obtaining the effect image corresponding to the image to be processed.

### CROSS-REFERENCE TO RELATED APPLICATION(S)

This disclosure claims the priority to Chinese Patent Application No. 202210080899.7, filed with the Chinese Patent Office on Jan. 24, 2022, which is incorporated herein by reference in its entirety.

### FIELD

Examples of the disclosure relate to the technical field of image processing, and relate to, for example, a method and apparatus for processing an effect image, an electronic device, and a storage medium.

### BACKGROUND

The video shooting boom occurs as various types of video shooting software are developed. In order to make shot videos fun, a variety of effects are added thereinto during shooting.

However, in the related art, added effects can be views drawn with augmented reality (AR) brushes. The added effects deviate greatly from actual images in real scenarios due to lack of considerations of actual factors. Thus, rendered effects are far from being authentic or aesthetic, and provide terrible user experience.

### SUMMARY

The disclosure provides a method and apparatus for processing an effect image, an electronic device, and a storage medium, so as to process an image into an effect image consistent with an actual drawing effect. Thus, authenticity of the effect image is improved, and user experience is further improved.

In a first aspect, an example of the disclosure provides a method for processing an effect image. The method includes:
obtaining an image to be processed;
determining a brush model to be rendered that corresponds to the image to be processed; and
rendering, according to a drawing parameter, a line to be rendered in the brush model to be rendered, and obtaining the effect image corresponding to the image to be processed.

In a second aspect, the example of the disclosure further provides an apparatus for processing an effect image. The apparatus includes:
an image obtainment module configured to obtain an image to be processed;
a model determination module configured to determine a brush model to be rendered that corresponds to the image to be processed; and
an effect image determination module configured to render, according to a drawing parameter, a line to be rendered in the brush model to be rendered, and obtain the effect image corresponding to the image to be processed.

In a third aspect, the example of the disclosure further provides an electronic device. The electronic device includes:
a processor; and
a memory configured to store a program, where
the processor implements the method for processing an effect image according to any example of the disclosure when the program is executed by the processor.

In a fourth aspect, the example of the disclosure further provides a storage medium. The storage medium includes computer-executable instructions, where the computer-executable instruction are configured to execute the method for processing an effect image according to any example of the disclosure when executed by a computer processor.

### BRIEF DESCRIPTION OF THE DRAWINGS

Throughout the accompanying drawings, the same or similar reference numerals indicate the same or similar elements. It should be understood that the accompanying drawings are schematic and components and elements are not necessarily drawn to scale.

FIG. 1 is a schematic flowchart of a method for processing an effect image according to Example 1 of the disclosure;

FIG. 2 is a schematic structural diagram of an apparatus for processing an effect image according to Example 3 of the disclosure; and

FIG. 3 is a schematic structural diagram of an electronic device according to Example 4 of the disclosure.

### DETAILED DESCRIPTION OF EMBODIMENTS

Examples of the disclosure will be described below with reference to accompanying drawings. Although some examples of the disclosure are shown in the accompanying drawings, it should be understood that the disclosure can be implemented in various forms and should not be constructed as limited to the examples set forth herein. It should be understood that the accompanying drawings and the examples of the disclosure are merely illustrative.

It should be understood that a plurality of steps described in a method embodiment of the disclosure can be executed in different orders and/or in parallel. Further, the method embodiment can include an additional step and/or omit a shown step.

As used herein, the terms “comprise” and “include” and their variations are open-ended, that is, “comprise but not limited to” and “include but not limited to”. The term “based on” indicates “at least partially based on”. The term “an example” indicates “at least one example”. The term “another example” indicates “at least one another example”. The term “some examples” indicates “at least some examples”. Related definitions of other terms will be given in the following description.

It should be noted that concepts such as “first” and “second” mentioned in the disclosure are merely used to distinguish different apparatuses, modules or units, rather than limit an order or interdependence of functions executed by these apparatuses, modules or units.

It should be noted that modifications with “a”, “an” and “a plurality of” mentioned in the disclosure are schematic, and should be understood by those skilled in the art as “one or more” unless otherwise definitely indicated in the context.

Before introducing a technical solution, an application scenario can be illustratively described at first. The technical solution of the disclosure may be applied to any scenario requiring effect display. The scenario may be a scenario to which an effect is required to be added during video calling, live broadcasting and short video shooting. A corresponding application program may be developed based on contents disclosed in the technical solution, or may be used as an effect prop in the video shooting scenario. Thus, the effect display of the corresponding contents is implemented with the effect prop. During effect making, a corresponding effect image may be drawn with an augmented reality (AR) brush. A drawing material for the AR brush is a syrup material. The syrup material may be understood as a product after solid sugar is heated. When an image is drawn with syrup, different syrup thicknesses correspond to different sugar color depths. The technical solution provided by the example of the disclosure may be applied to the situation that the AR brush is used to draw an effect image adapted to festival atmosphere and the effect image is displayed. The festival atmosphere may be Spring Festival atmosphere and a festival effect may be a sugar painting effect. The contents of a sugar painting may be determined by a preset template, or the sugar painting may be an image drawn freely according to preference of a user. The festive atmosphere may be the Spring Festival atmosphere. Alternatively, a shot image to be processed is processed into a corresponding sugar painting image, that is, a corresponding effect image is drawn for the image to be processed by using the syrup as the drawing material.

### Example 1

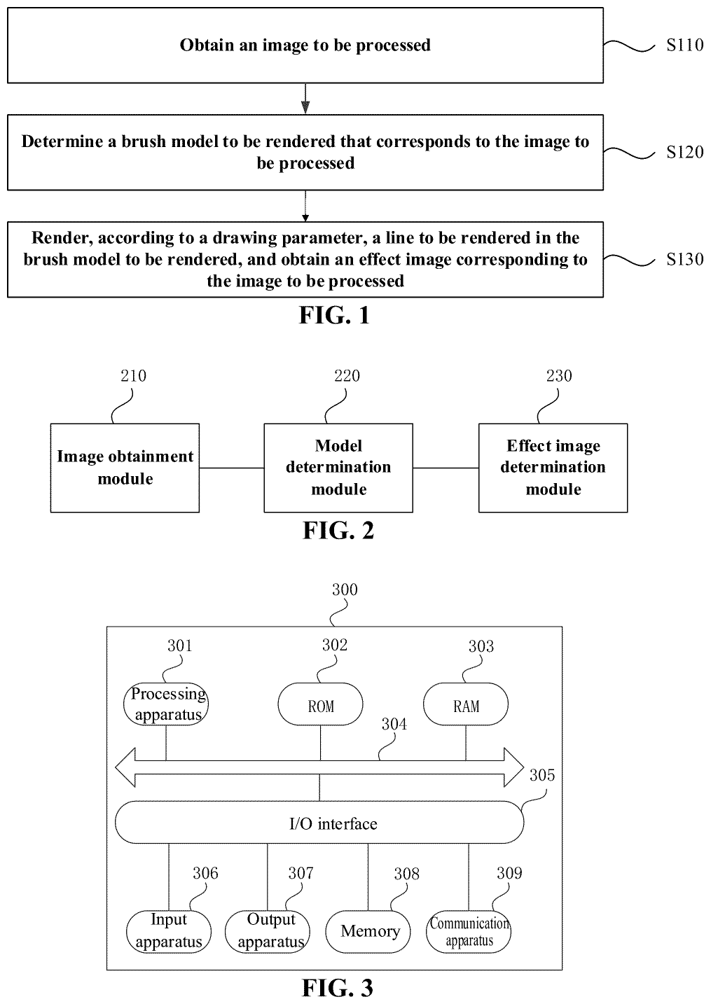

FIG. 1 is a schematic flowchart of a method for processing an effect image according to Example 1 of the disclosure. The example of the disclosure is applied to a situation that the image to be processed is processed into a corresponding effect image and the effect image is displayed in any image display scenario supported by the Internet. This method may be implemented through an apparatus for processing an effect image. This apparatus may be implemented in the form of software and/or hardware, optionally, in an electronic device. The electronic device may be a mobile terminal or a personal computer (PC) terminal, a server, etc. Any image display scenario is usually implemented through cooperation between a client and the server. The method provided in this example may be executed by the server, the client or the client cooperating with the server.

As shown in FIG. 1, the method according to the example of the disclosure includes:

S110. An image to be processed is obtained.

The image to be processed may be an image that needs effect conversion. Optionally, an image shot in real time based on a camera device is taken as the image to be processed. The image to be processed includes at least one target object. The target object may be a user, a pet, a mountain, a river, etc. The image to be processed may also be a preset target object requiring effect processing, and after the image to be processed is obtained, the target object in the image to be processed is automatically determined, to perform effect processing on the target object. The image to be processed may also be an image uploaded by triggering an upload control by the user, and the image uploaded is taken as the image to be processed.

It should be noted that the image to be processed may be the image shot in real time by the camera device or the image uploaded by the user. The image to be processed may be set specifically according to actual requirements. It should also be noted that the technical solution may be integrated into a corresponding application program, and the camera device may be a terminal device into which the application program is integrated accordingly.

S120. A brush model to be rendered that corresponds to the image to be processed is determined.

The brush model to be rendered is the model to be rendered after the image to be processed is processed. The brush model to be rendered is consistent with a contour in the image to be processed. A line corresponding to the contour may have corresponding width values and gray values. Thus, a corresponding sugar painting drawing parameter is determined based on the width value and the gray value, and then the brush model to be rendered is rendered based on the sugar painting drawing parameter.

Illustratively, after the image to be processed is obtained, contour information of the target object in the image to be processed may be determined. In addition, a width value corresponding to the contour information may be determined, and the brush model to be rendered that corresponds to the image to be processed is obtained. Optionally, after the image to be processed is obtained, a body contour and a limb part contour of the target object in the image to be processed are determined, and width information of a contour line is determined. The width information of the contour line may indicate that a width value of a line at a turning point is larger, and a width value of a line far away from the turning point is smaller. In addition, a gray value of a pixel in the contour line is determined. Thus, the sugar painting drawing parameter is determined based on the gray value and the width value.

In this example, the brush model to be rendered that corresponds to the image to be processed is determined by two solutions. The two solutions for determining the brush model to be rendered that corresponds to the image to be processed will be described below.

According to a first embodiment, according to the image to be processed and a target contrast view, the brush model to be rendered is determined.

The target contrast view may be a view having a preset gray value. Optionally, the preset gray value may be 0, that is, the target contrast view is a pure black view or a pure color view with a gray value close to 0. By superposing the target contrast view onto the image to be processed, a contour image corresponding to the image to be processed may be obtained. In addition, a width value of a line of the contour image may be determined according to definition of the contour image. Optionally, the higher a definition value is, the higher a corresponding width value is.

After the width information is obtained, the gray value of a corresponding pixel in the contour image may be determined. Thus, a corresponding rendering parameter may be retrieved based on the gray value for rendering the contour image, and the brush model to be rendered is obtained. In an example, if the image to be processed is the shot image shot through the camera device in real time or uploaded by the user, contour information corresponding to the image to be processed may be determined based on the target contrast view. Then, the contour information is processed to obtain the brush model to be rendered.

According to a second embodiment, the step that the brush model to be rendered that corresponds to the image to be processed is determined includes: a drawn trajectory on a display interface is taken as the image to be processed; two adjacent pause points in the drawn trajectory are obtained, and according to attributes of a pause point and the image to be processed, the brush model to be rendered is determined; the attributes of the pause point include pause duration and a pause instant at the pause point.

In an actual application, when the user draws a corresponding image to be processed, an image including a drawn content may be recorded with the camera device. The drawn contents are mostly determined according to motion of a corresponding key point. Optionally, a key point may be a key point on a face of a target object in a shot picture. Optionally, a nasal tip serves as the key point, and the drawn content is drawn according to motion of the nasal tip. An image drawn by moving a finger on the display interface may also serve as the image to be processed. That is, a corresponding motion trajectory may be drawn and used as the drawn trajectory. Accordingly, an image corresponding to the drawn trajectory is used as the image to be processed. When a trajectory is drawn based on the key point, a corresponding pause point exits. The attributes of the pause point include the pause duration and the pause instant. The pause duration refers to duration of stay at a pause point, and the pause instant may refer to pause time. By determining the pause instant, thickness information of a trajectory line between two adjacent pause points, that is, the width information. By determining the duration of stay, sugar quantity information at this pause point may be determined. Based on the above information, the brush model to be rendered may be determined corresponding to the drawn trajectory in the image to be processed.

In this example, the brush model to be rendered may be determined based on the above information in a method as follows, for example, the image to be processed is generated based on the drawn trajectory. During drawing, data corresponding to the drawn trajectory are received. The data may include the motion trajectory and the pause point information. According to the pause instant of the pause point, adjacent pause points are determined. According to pause duration of the adjacent pause points, a thickness and a size of a drawing paint at this pause point are determined. In addition, according to pause instants and a trajectory of the adjacent pause points, a trajectory width between the two adjacent pause points may be determined. Thus, the brush model to be rendered that corresponds to the image to be processed is obtained.

In this example, while the trajectory width is obtained, a gray value corresponding to a respective pixel in a corresponding contour image may also be determined after the determined width information of the image to be processed is obtained in order to determine a final rendering effect. Thus, a schematic diagram of a sugar painting in a real environment is simulated. For example, when an image of a pet, a figure, a green hill, etc. is drawn with boiled sugar in a real scenario, a schematic effect diagram with different thickness, sugar color depths and thicknesses according to duration of stay in a position or a motion speed information.

In order to simulate the above effect, the following operations can be adopted: a gray value of a corresponding pixel in a line to be rendered in the brush model to be rendered is determined. According to width information of the line in the brush model to be rendered, a line width change rate is determined. A Fresnel value of a pixel is determined according to a normal vector of the pixel in the brush model to be processed and a camera normal vector corresponding to the brush model to be processed. According to the Fresnel value of the pixel and a corresponding width change rate, gray information of the pixel in the brush model to be processed is determined. The sugar painting drawing parameter is determined according to the gray information.

The width change rate is determined according to line width information at a previous instant and line width information at a next instant. The model to be rendered corresponds to the contour image, and the contour image is composed of a plurality of pixels accordingly. In this case, a normal view corresponding to the contour image may be determined. For each pixel, the Fresnel value of the corresponding pixel may be determined according to normal information of the pixel and the camera normal vector. The Fresnel value refers to a reflectivity in a Fresnel effect. The reflectivity value is used to represent a quantity of reflected contents, that is, a brightness of the image. Optionally, the higher the reflectivity value is, the brighter the image is. The lower the reflectivity is, the lower the brightness of the image is. With a ball as an example, a reflection quantity is smaller in a middle and larger on two sides. A contour image is composed of lines, and a line is composed of a plurality of pixels. The Fresnel value may be understood as an intermediate transitional value rate. The brightness of an image may be represented by the Fresnel value. Based on the Fresnel value and the corresponding change rate, the gray value corresponding to the respective pixel in the line to be rendered may be determined. In addition, light quantity information corresponding to the line to be rendered may be determined. According to the light quantity information and the corresponding gray value, the sugar painting drawing parameter of the corresponding pixels may be retrieved. Then, the corresponding line to be rendered is rendered based on the sugar painting drawing parameter. The sugar painting drawing parameter includes a syrup depth, a thickness and a brightness at the pixel, etc.

S130. According to a drawing parameter, a line to be rendered in the brush model to be rendered is rendered, and an effect image corresponding to the image to be processed is obtained.

For example, the drawing parameter includes a drawing paint and a paint parameter, the drawing paint is a liquid paint, the liquid paint includes ink or syrup, and the paint parameter includes a paint depth of the liquid paint and a reflected light quantity of the paint consistent with the reflected light quantity information. In this example, drawing of the sugar painting may be used as an example for description. The corresponding drawing parameter is mainly the sugar painting drawing parameter. The sugar painting drawing parameter includes at least one of sugar color depth information, syrup thickness information and syrup brightness information. It can be understood that the sugar painting drawing parameter includes at least one of the three attributes. Attribute values corresponding to the different attributes are also different, and the attribute values corresponding to the different attributes may be determined respectively. Based on the gray information corresponding to each pixel in the brush model to be rendered, the corresponding sugar painting drawing parameter may be retrieved for rendering, and the effect image is obtained accordingly.

It should be noted that effects presented based on different sugar painting drawing parameters are different. For example, a position with a smaller line width value, the position is lighter in color and transparent. A position with a greater line width value, the position is darker in color and opaque. In addition, since the sugar painting is made, sugar is heated into a liquid state from a solid state, presents ruddy and transparent in texture, and has certain reflection and refraction effects accordingly. Thus, in the technical solution, the sugar painting drawing parameter may be determined based on the above parameter. In this example, the steps that according to a sugar painting drawing parameter, a line to be rendered in the brush model to be rendered is rendered, and an effect image corresponding to the image to be processed is obtained, include: a gray value of a pixel in the line to be rendered and an illumination parameter corresponding to the image to be processed are determined; a corresponding sugar painting drawing parameter is retrieved according to the gray value and the illumination parameter; a corresponding pixel is rendered based on the sugar painting drawing parameter, and the effect image is obtained.

Illustratively, the contour image corresponding to the image to be processed may be determined. In addition, a large width is set for a line with high definition in the contour image, and a small width is set for a line with low definition in the contour image. It is clear that the width value of the line to be rendered may also be determined according to the attributes of the pause point of the drawn trajectory. After the above information is determined, the width change rate corresponding to the line to be rendered may be determined, and the Fresnel value of the pixel may be further determined. According to the width change rate and the Fresnel value, corresponding gray information may be determined. It is determined that a thickest line to be rendered has a greatest gray value, that is, black. With a black area as a center point, an interpolation operation is performed externally, and the gray value of the corresponding pixel in the line to be rendered is obtained. According to the gray value, and the light quantity information of the image to be processed, the sugar painting drawing parameter corresponding to the respective pixel may be retrieved to render the corresponding pixel. Thus, the effect image is obtained.

According to the technical solution of the example of the disclosure, after the image to be processed is obtained, the brush model to be rendered that corresponds to the image to be processed may be determined. The corresponding line to be rendered in the brush model to be rendered is rendered based on the predetermined sugar painting drawing parameter, and the effect image consistent with the actual sugar painting effect is obtained. The effect image can be displayed in the display interface. Thus, the problem that in the prior art, drawn views deviate greatly from actual images since the views uses the augmented reality brush without considering actual factors, effect images are far from being satisfactory, and provide terrible user experience is solved. The line to be rendered in the brush model to be rendered is rendered according to the drawing parameter, and the corresponding effect image is obtained. Thus, authenticity of the effect image is improved, and the user experience is further improved.

### Example 2

On the basis of the above example, a sugar painting drawing parameter may be determined at first. Technical terms that are the same as or corresponding to those in the above example are not repeated herein.

On the basis of the above solution, a brush model to be processed may be obtained at first. Then, the sugar painting drawing parameter corresponding to respective gray information may be determined according to the brush model to be processed. In this example, the brush model to be processed may be determined by following operations: according to width information of a line in the brush model to be processed, a line width change rate is determined; a Fresnel value of a pixel is determined according to a normal vector of a pixel in the brush model to be processed and a camera normal vector corresponding to the brush model to be processed; according to the Fresnel value of the pixel and a corresponding width change rate, gray information of the pixel in the brush model to be processed is determined; and the drawing parameter is determined according to the gray information.

Illustratively, the brush model to be processed may be a pre-drawn image in a shape. A line width of the image may be the same or not. It is clear that in order to simulate an actual effect, the line width may be different. An adjustment step of the line change rate may be set. Width information of a previous point and width information of a next point may be determined according to the adjustment step, and the width change rate may be determined according to the width information. The Fresnel value refers to numerical information obtained through scalar multiplication on the normal information corresponding to the pixel and the camera normal vector of the brush model to be processed. The Fresnel value is determined by computing a scalar product of the normal vector information of each pixel and the camera normal vector. The Fresnel value is used to represent brightness information of a corresponding line. According to the Fresnel value corresponding to the respective pixel and the width change rate corresponding to the respective pixel, the gray information of the corresponding pixel in the brush model to be processed may be determined. The sugar painting drawing parameter may be determined according to the gray information. The sugar painting drawing parameter includes sugar color depth information and reflection brightness information.

In this example, the step that according to the Fresnel value of the pixel and a corresponding width change rate, gray information of the pixel in the brush model to be processed is determined includes: the gray value of a corresponding pixel is determined through a scalar multiplication operation on the width change rate and a corresponding Fresnel value.

Illustratively, the Fresnel value of the corresponding pixel and the width change rate of the line to which the pixel belongs may be subjected to the scalar multiplication operation. Then, the gray value of the corresponding pixel may be determined based on a result of the scalar multiplication operation, and the gray value may be taken as the gray information.

Based on the technical solution described above, the step that the sugar painting drawing parameter is determined according to the gray information includes: a dark color area and a light color area according to a gray value are determined, and a first predetermined drawing parameter to be fused that corresponds to the dark color area and a second predetermined drawing parameter to be fused that corresponds to the light color area are obtained; the first drawing parameter to be fused and the second drawing parameter to be fused are processed based on an interpolation operation, and the drawing parameter corresponding to a respective gray value is determined.

The first drawing parameter to be fused may be understood as the sugar color parameter when the dark color area is drawn. The sugar color parameter may include the sugar color depth. Generally, the sugar color in the dark color area is deeper, that is, a sugar color depth value is larger. The second parameter to be fused may be understood as the sugar color parameter when the light color area is drawn. The depth color area and the light color area are determined based on a predetermined gray value. Optionally, an area composed of pixels that have gray values higher than a first preset gray threshold is regarded as the dark color area, and usually corresponds to an area where a turning point in an image belongs. An area composed corresponding to pixels that have gray values smaller than a second preset gray threshold is regarded as the light color area, and usually corresponds to an area far away from the turning point in the image. Sugar color parameters of the dark color area and the light color area may be predetermined and used as the drawing parameters to be fused. Based on the drawing parameters to be fused, the gray value of the dark color area and the gray value of the light color area, the interpolation operation may be performed, so as to determine the sugar painting drawing parameter of the pixels on the line between the dark color area and the light color area. The sugar painting drawing parameter determined in this case may be bound with the corresponding gray value, such that the corresponding drawing parameter can be retrieved for image drawing when the image to be processed is rendered.

Based on the technical solution described above, reflected light quantity information corresponding to gray information under different illumination parameters is determined. Based on the reflected light quantity information, the sugar painting drawing parameter corresponding to respective gray information is updated.

In an actual application, reflected brightness values of syrup (molasses) are different under different brightness conditions. In order to simulate the most realistic effect, the reflected light quantity information of syrup under different illumination parameters may be determined. The illumination parameters may include an illumination intensity and an illumination angle. A virtual light source is controlled to illuminate the brush model to be processed based on the illumination parameter, so as to obtain corresponding reflected light quantity information. The reflected light quantity information corresponding to different gray information is updated to the corresponding sugar painting drawing parameter for later retrieval.

According to the technical solution of the example of the disclosure, before the line in the brush model to be rendered is rendered, the gray information of the corresponding pixel in the line to be rendered may be determined. A matching sugar painting drawing parameter is retrieved according to the gray information, and the corresponding pixel may be rendered based on the sugar painting drawing parameter, such that the effect image corresponding to the image to be processed can be obtained. The effect image can be most matching to the actual situation, and user experience is further improved.

### Example 3

FIG. 2 is a schematic structural diagram of an apparatus for processing an effect image according to Example 3 of the disclosure. As shown in FIG. 2, the apparatus includes: an image obtainment module 210, a model determination module 220 and an effect image determination module 230.

The image obtainment module 210 is configured to obtain an image to be processed. The model determination module 220 is configured to determine a brush model to be rendered that corresponds to the image to be processed. The effect image determination module 230 is configured to render, according to a drawing parameter, a line to be rendered in the brush model to be rendered, and obtain the effect image corresponding to the image to be processed.

Based on the technical solution described above, the model determination module is configured to determine the brush model to be rendered that corresponds to the image to be processed by following operations: according to the image to be processed and a target contrast view, the brush model to be rendered is determined.

Based on the technical solution described above, the model determination module includes:
an image determination unit configured to take a drawn trajectory on a display interface as the image to be processed; and
a model determination unit configured to obtain two adjacent pause points in the drawn trajectory, and determine, according to attributes of the pause point and the image to be processed, the brush model to be rendered; where the attributes of the pause point include pause duration and a pause instant at the pause point.

Based on the technical solutions described above, the apparatus further includes:
a change rate determination module configured to determine a line width change rate according to width information of the line in the brush model to be processed;
a Fresnel value determination module configured to determine a Fresnel value of a pixel according to a normal vector of the pixel in the brush model to be processed and a camera normal vector corresponding to the brush model to be processed;
a gray information determination module configured to determine, according to the Fresnel value of the pixel and a corresponding width change rate, gray information of the pixel in the brush model to be processed; and
a drawing parameter determination module configured to determine the drawing parameter according to the gray information.

Based on the technical solutions described above, the gray information determination module is configured to determine, the gray information of the pixel in the brush model to be processed by following operations: the gray information of a corresponding pixel is determined through a scalar multiplication operation on the width change rate and a corresponding Fresnel value.

Based on the technical solution described above, the gray information determination module includes:
a drawing parameter retrieval unit configured to determine a dark color area and a light color area according to a gray value, and obtain a first predetermined drawing parameter to be fused that corresponds to the dark color area and a second predetermined drawing parameter to be fused that corresponds to the light color area; and
a drawing parameter fusion unit configured to process the first drawing parameter to be fused and the second drawing parameter to be fused based on an interpolation operation, and determine the drawing parameter corresponding to a respective gray value.

Based on the technical solution described above, the apparatus further includes:
a light quantity information determination module configured to determine reflected light quantity information corresponding to gray information under different illumination parameters; and
a drawing parameter determination module configured to update, based on the reflected light quantity information, the drawing parameter corresponding to respective gray information.

Based on the technical solution described above, the drawing parameter includes a drawing paint and a paint parameter, the drawing paint is a liquid paint, the liquid paint includes ink or syrup, and the paint parameter includes a paint depth of the liquid paint and a reflected light quantity of the paint consistent with the reflected light quantity information.

Based on the technical solution described above, the effect image determination module includes:
a parameter determination unit configured to determine a gray value of a pixel in the line to be rendered and an illumination parameter corresponding to the image to be processed;
a parameter retrieval unit configured to retrieve a corresponding drawing paint and a corresponding paint parameter according to the gray value and the illumination parameter; and
an effect image determination unit configured to render a corresponding pixel based on the drawing paint and the paint parameter, and obtain the effect image.

According to the technical solution of the example of the disclosure, after the image to be processed is obtained, the brush model to be rendered that corresponds to the image to be processed may be determined. The corresponding line to be rendered in the brush model to be rendered is rendered based on the predetermined sugar painting drawing parameter, and the effect image consistent with the actual sugar painting effect is obtained. The effect image can be displayed in the display interface. Thus, the problem that in the relevant solutions, drawn views deviate greatly from actual images since the views uses the augmented reality brush without considering actual factors, effect images are far from being satisfactory, and provide terrible user experience is solved. The line to be rendered in the brush model to be rendered is rendered according to the drawing parameter, and the corresponding effect image is obtained. Thus, authenticity of the effect image is improved, and the user experience is further improved.

The apparatus for processing an image according to the example of the disclosure may execute the method for processing an effect image according to any example of the disclosure, and has corresponding functional modules and benefits for executing the method.

It is worth noting that all the units and modules included in the apparatus above are merely divided according to a functional logic, but are not limited to the above division, as long as the corresponding functions may be performed. In addition, names of the functional units are merely for the convenience of mutual distinguishing.

### Example 4

FIG. 3 is a schematic structural diagram of an electronic device according to Example 4 of the disclosure. With reference to FIG. 3, a schematic structural diagram of an electronic device 300 (for example, a terminal device or a server in FIG. 3) applied to implementation of the example of the disclosure is shown. The terminal device in the example of the disclosure may include a mobile terminal such as a mobile phone, a laptop, a digital broadcast receiver, a personal digital assistant (PDA), a portable android device (PAD), a portable media player (PMP) and a vehicle-mounted terminal (such as a vehicle-mounted navigation terminal), and a fixed terminal such as a digital television (that is, a digital TV) and a desktop computer. The electronic device shown in FIG. 3 is merely one instance.

As shown in FIG. 3, the electronic device 300 may include a processing apparatus 301 (including a central processing unit, a graphics processing unit, etc.) that may execute various appropriate actions and processing according to a program stored in a read-only memory (ROM) 302 or a program loaded from a memory 308 to a random access memory (RAM) 303. The RAM 303 may further store various programs and data required for the operation of the electronic device 300. The processing apparatus 301, the ROM 302 and the RAM 303 are connected to one another through a bus 304. An input/output (I/O) interface 305 is also connected to the bus 304.

Generally, the following apparatuses may be connected to the I/O interface 305: an input apparatus 306 including, for example, a touch screen, a touch pad, a keyboard, a mouse, a camera, a microphone, an accelerometer and a gyroscope, an output apparatus 307 including, for example, a liquid crystal display (LCD), a speaker and a vibrator, the memory 308 including, for example, a magnetic tape and a hard disk, and a communication apparatus 309. The communication apparatus 309 may allow the electronic device 300 to be in wireless or wired communication with other devices for data exchange. Although the electronic device 300 having various apparatuses is shown in FIG. 3, it should be understood that all the apparatuses shown are not required to be implemented or provided. More or fewer apparatuses may be alternatively implemented or provided.

According to the example of the disclosure, a process described above with reference to the flowchart may be implemented as a computer software program in an example. For example, the example of the disclosure includes a computer program product. The computer program product includes a computer program carried on a non-transient computer-readable medium, and the computer program includes program codes for executing the method shown in the flowchart. In such an example, the computer program may be downloaded and mounted from the network through the communication apparatus 309, or installed from the memory 308, or installed from the ROM 302. When executed by the processing apparatus 301, the computer program executes the above functions defined in the method according to the example of the disclosure.

Names of messages or information exchanged among a plurality of apparatuses in the embodiment of the disclosure are merely used for illustration rather than limitation to the scope of the messages or information.

The electronic device according to the example of the disclosure belongs to the same inventive concept as the method for processing an effect image according to the above example, reference can be made to the above example for the technical details not described in detail in this example, and this example has the same beneficial effects as the above example.

### Example 5

An example of the disclosure provides a computer storage medium. The computer storage medium stores a computer program, where the computer program implements the method for processing an effect image according to the above example when executed by a processor.

It should be noted that the computer-readable medium described above in the disclosure may be a computer-readable signal medium or a computer-readable storage medium or their combinations. The computer-readable storage medium may be, for example, an electric, magnetic, optical, electromagnetic, infrared, or semiconductor system, apparatus or device, or any one of their combinations. An instance of the computer-readable storage medium may include: an electrical connection with at least one wire, a portable computer disk, a hard disk, an RAM, an ROM, an erasable programmable read only memory (EPROM or a flash memory), an optical fiber, a portable compact disc-read only memory (CD-ROM), an optical storage device, a magnetic storage device, or their suitable combinations. In the disclosure, the computer-readable storage medium may be any tangible medium including or storing a program, and the program may be used by or in combination with an instruction execution system, apparatus or device. In the disclosure, the computer-readable signal medium may include a data signal propagated in a baseband or as part of a carrier wave, in which a computer-readable program code is carried. This propagated data signal may have many forms, including an electromagnetic signal, an optical signal or their suitable combinations. The computer-readable signal medium may further be any computer-readable medium other than the computer-readable storage medium, and the computer-readable signal medium may send, propagate or transmit a program used by or in combination with the instruction execution system, apparatus or device. The program code included in the computer-readable medium may be transmitted by any suitable medium, including a wire, an optical cable, a radio frequency (RF), etc., or their suitable combinations.

In some embodiments, a client and a server may communicate by using any network protocol such as the hyper text transfer protocol (HTTP) that is currently known or will be developed in future, and may be interconnected to digital data communication in any form or medium (for example, a communication network). Instances of the communication network include a local area network (LAN), a wide area network (WAN), internet work (for example, the Internet), an end-to-end network (for example, adhoc end-to-end network), and any network that is currently known or will be developed in future.

The computer-readable medium may be included in the electronic device, or exist independently without being fitted into the electronic device.

The computer-readable medium carries at least one program, and when executed by the electronic device, the at least one program causes the electronic device to:
obtaining an image to be processed;
determining a brush model to be rendered that corresponds to the image to be processed; and
rendering, according to a drawing parameter, a line to be rendered in the brush model to be rendered, and obtaining the effect image corresponding to the image to be processed.

Computer program codes for executing the operations of the disclosure may be written in one or more programming languages or their combinations, and the programming languages include object-oriented programming languages including Java, Smalltalk, C++, and further include conventional procedural programming languages including “C” language or similar programming languages. The program codes may be completely executed on a computer of the user, partially executed on the computer of a user, executed as an independent software package, partially executed on the computer of the user and a remote computer separately, or completely executed on the remote computer or the server. In the case of involving the remote computer, the remote computer may be connected to the computer of the user through any type of network, including a local area network (LAN) or a wide area network (WAN), or may be connected to an external computer (for example, through the Internet provided by an Internet service provider).

The flowcharts and block diagrams in the accompanying drawings illustrate the architectures, functions and operations that may be implemented by the systems, the methods and the computer program products according to various examples of the disclosure. In this regard, each block in the flowchart or block diagram may represent one module, one program segment, or a part of codes that includes at least one executable instruction for implementing specified logical functions. It should also be noted that in some alternative implementations, the functions indicated in the blocks may occur in an order different than those indicated in the accompanying drawings. For example, two blocks indicated in succession may actually be executed in substantially parallel, and may sometimes be executed in a reverse order depending on the functions involved. It should also be noted that each block in the block diagram and/or flowchart, and a combination of blocks in the block diagram and/or flowchart may be implemented by a specific hardware-based system that executes specified functions or operations, or may be implemented by a combination of specific hardware and computer instructions.

The units involved in the example of the disclosure may be implemented by software or hardware. A name of the unit does not constitute limitation to the unit itself in some cases. For example, a first obtainment unit may also be described as “a unit that obtains at least two Internet protocol addresses”.

The functions described above herein may be executed at least in part by at least one hardware logic component. For example, usable hardware logic components of demonstration types include a field programmable gate array (FPGA), an application specific integrated circuit (ASIC), application specific standard parts (ASSP), a system on chip (SOC), a complex programmable logic device (CPLD), etc.

In the context of the disclosure, a machine-readable medium may be a tangible medium, and may include or store a program that is used by or in combination with the instruction execution system, apparatus or device. The machine-readable medium may be a machine-readable signal medium or a machine-readable storage medium. The machine-readable storage medium may include an electric, magnetic, optical, electromagnetic, infrared, or semiconductor system, apparatus or device, or their suitable combinations. An instance of the machine-readable storage medium may includes an electrical connection based on at least one wire, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or their suitable combinations.

According to one or more examples of the disclosure, [Instance 1] provides a method for processing an effect image. The method includes:
An image to be processed is obtained;
A brush model to be rendered that corresponds to the image to be processed is determined;
According to a drawing parameter, a line to be rendered in the brush model to be rendered is rendered, and the effect image corresponding to the image to be processed is obtained.

According to one or more examples of the disclosure, [Instance 2] provides the method for processing an effect image. The method further includes:

Optionally, the step that a brush model to be rendered that corresponds to the image to be processed is determined includes:

According to the image to be processed and a target contrast view, the brush model to be rendered is determined.

According to one or more examples of the disclosure, [Instance 3] provides the method for processing an effect image. The method further includes:

Optionally, the step that a brush model to be rendered that corresponds to the image to be processed is determined includes:

A drawn trajectory on a display interface is taken as the image to be processed;
Two adjacent pause points in the drawn trajectory are obtained, and according to an attribute of the pause point and the image to be processed, the brush model to be rendered is determined;
The attributes of the pause point include pause duration and a pause instant at the pause point.

According to one or more example of the disclosure, [Instance 4] provides the method for processing an effect image. The method further includes:
Optionally, a line width change rate is determined according to width information of the line in the brush model to be processed;
A Fresnel value of a pixel is determined according to a normal vector of the pixel in the brush model to be processed and a camera normal vector corresponding to the brush model to be processed;
According to the Fresnel value of the pixel and a corresponding width change rate, gray information of the pixel in the brush model to be processed is determined;
The drawing parameter is determined according to the gray information.

According to one or more examples of the disclosure, [Instance 5] provides the method for processing an effect image. The method further includes:

Optionally, the step that according to the Fresnel value of the pixel and a corresponding width change rate, gray information of the pixel in the brush model to be processed is determined includes:

The gray information of a corresponding pixel is determined through a scalar multiplication operation on the width change rate and a corresponding Fresnel value.

According to one or more examples of the disclosure, [Instance 6] provides the method for processing an effect image. The method further includes:

Optionally, a dark color area and a light color area are determined according to a gray value, and a first predetermined drawing parameter to be fused that corresponds to the dark color area and a second predetermined drawing parameter to be fused that corresponds to the light color area are obtained.

The first drawing parameter to be fused and the second drawing parameter to be fused are processed based on an interpolation operation, and the drawing parameter corresponding to a respective gray value is determined.

According to one or more examples of the disclosure, [Instance 7] provides the method for processing an effect image. The method further includes:
Optionally, reflected light quantity information corresponding to gray information under different illumination parameters is determined;
Based on the reflected light quantity information, the drawing parameter corresponding to respective gray information is updated.

According to one or more examples of the disclosure, [Instance 8] provides the method for processing an effect image. The method further includes:

Optionally, the drawing parameter includes a drawing paint and a paint parameter, the drawing paint is a liquid paint, the liquid paint includes ink or syrup, and the paint parameter includes a paint depth of the liquid paint and a reflected light quantity of the paint consistent with the reflected light quantity information.

According to one or more examples of the disclosure, [Instance 9] provides the method for processing an effect image. The method further includes:

Optionally, the steps that according to a sugar painting drawing parameter, a line to be rendered in the brush model to be rendered is rendered, and the effect image corresponding to the image to be processed is obtained include:

A gray value of a pixel in the line to be rendered and an illumination parameter corresponding to the image to be processed are determined;
A corresponding sugar painting drawing parameter is retrieved according to the gray value and the illumination parameter;
A corresponding pixel is rendered based on the sugar painting drawing parameter, and the effect image is obtained.

According to one or more examples of the disclosure, [Instance 10] provides an apparatus for processing an effect image. The apparatus includes:
an image obtainment module configured to obtain an image to be processed;
a model determination module configured to determine a brush model to be rendered that corresponds to the image to be processed; and
an effect image determination module configured to render, according to a drawing parameter, a line to be rendered in the brush model to be rendered, and obtain the effect image corresponding to the image to be processed.

What is claimed is:

1. A method for processing an effect image, comprising:
obtaining an image to be processed;
determining a brush model to be rendered that corresponds to the image to be processed; and
rendering, according to a drawing parameter, a line to be rendered in the brush model to be rendered, and obtaining the effect image corresponding to the image to be processed.

2. The method according to claim 1, wherein the determining a brush model to be rendered that corresponds to the image to be processed comprises:
determining, according to the image to be processed and a target contrast view, the brush model to be rendered.

3. The method according to claim 1, wherein the determining a brush model to be rendered that corresponds to the image to be processed comprises:
taking a drawn trajectory on a display interface as the image to be processed; and
obtaining two adjacent pause points in the drawn trajectory, and determining, according to attributes of the pause point and the image to be processed, the brush model to be rendered;
wherein the attributes of the pause point comprise pause duration and a pause instant at the pause point.

4. The method according to claim 1, further comprising:
determining a line width change rate according to width information of the line in the brush model to be processed;
determining a Fresnel value of a pixel according to a normal vector of the pixel in the brush model to be processed and a camera normal vector corresponding to the brush model to be processed;
determining, according to the Fresnel value of the pixel and a corresponding width change rate, gray information of the pixel in the brush model to be processed; and
determining the drawing parameter according to the gray information.

5. The method according to claim 4, wherein the determining, according to the Fresnel value of the pixel and a corresponding width change rate, gray information of the pixel in the brush model to be processed comprises:
determining the gray information of a corresponding pixel through a scalar multiplication operation on the width change rate and a corresponding Fresnel value.

6. The method according to claim 4, wherein the determining the drawing parameter according to the gray information comprises:
determining a dark color area and a light color area according to a gray value, and obtaining a first predetermined drawing parameter to be fused that corresponds to the dark color area and a second predetermined drawing parameter to be fused that corresponds to the light color area; and
processing the first drawing parameter to be fused and the second drawing parameter to be fused based on an interpolation operation, and determining the drawing parameter corresponding to a respective gray value.

7. The method according to claim 6, further comprising:
determining reflected light quantity information corresponding to gray information under different illumination parameters; and
updating, based on the reflected light quantity information, the drawing parameter corresponding to respective gray information.

8. The method according to claim 1, wherein the drawing parameter comprises a drawing paint and a paint parameter, the drawing paint is a liquid paint, the liquid paint comprises ink or syrup, and the paint parameter comprises a paint depth of the liquid paint and a reflected light quantity of the paint consistent with the reflected light quantity information.

9. The method according to claim 8, wherein the rendering, according to a drawing parameter, a line to be rendered in the brush model to be rendered, and obtaining the effect image corresponding to the image to be processed comprise:
determining a gray value of a pixel in the line to be rendered and an illumination parameter corresponding to the image to be processed;
retrieving a corresponding drawing paint and a corresponding paint parameter according to the gray value and the illumination parameter; and
rendering a corresponding pixel based on the drawing paint and the paint parameter, and obtaining the effect image.

10-18. (canceled)

19. An electronic device, comprising:
a processor; and
a memory configured to store a program, when executed by the processor, causing the processor to:
obtain an image to be processed;
determine a brush model to be rendered that corresponds to the image to be processed; and
render, according to a drawing parameter, a line to be rendered in the brush model to be rendered, and obtain the effect image corresponding to the image to be processed.

20. A non-transitory computer-readable medium, comprising computer-executable instructions, wherein the computer-executable instructions when executed by a computer processor, cause the computer processor to:
obtain an image to be processed;
determine a brush model to be rendered that corresponds to the image to be processed; and
render, according to a drawing parameter, a line to be rendered in the brush model to be rendered, and obtain the effect image corresponding to the image to be processed.

21. The electronic device of claim 19, wherein the program further causes the processor to:
determine, according to the image to be processed and a target contrast view, the brush model to be rendered.

22. The electronic device of claim 19, wherein the program further causes the processor to:
take a drawn trajectory on a display interface as the image to be processed; and
obtain two adjacent pause points in the drawn trajectory, and determine, according to attributes of the pause point and the image to be processed, the brush model to be rendered;
wherein the attributes of the pause point comprise pause duration and a pause instant at the pause point.

23. The electronic device of claim 19, wherein the program further causes the processor to:
determine a line width change rate according to width information of the line in the brush model to be processed;
determine a Fresnel value of a pixel according to a normal vector of the pixel in the brush model to be processed and a camera normal vector corresponding to the brush model to be processed;
determine, according to the Fresnel value of the pixel and a corresponding width change rate, gray information of the pixel in the brush model to be processed; and
determine the drawing parameter according to the gray information.

24. The electronic device of claim 22, wherein the program further causes the processor to:
determine the gray information of a corresponding pixel through a scalar multiplication operation on the width change rate and a corresponding Fresnel value.

25. The electronic device of claim 22, wherein the program further causes the processor to:
determine a dark color area and a light color area according to a gray value, and obtain a first predetermined drawing parameter to be fused that corresponds to the dark color area and a second predetermined drawing parameter to be fused that corresponds to the light color area; and
process the first drawing parameter to be fused and the second drawing parameter to be fused based on an interpolation operation, and determine the drawing parameter corresponding to a respective gray value.

26. The electronic device of claim 24, wherein the program further causes the processor to:
determine reflected light quantity information corresponding to gray information under different illumination parameters; and
update, based on the reflected light quantity information, the drawing parameter corresponding to respective gray information.

27. The electronic device of claim 19, wherein the drawing parameter comprises a drawing paint and a paint parameter, the drawing paint is a liquid paint, the liquid paint comprises ink or syrup, and the paint parameter comprises a paint depth of the liquid paint and a reflected light quantity of the paint consistent with the reflected light quantity information.

28. The electronic device of claim 26, wherein the program further causes the processor to:
determine a gray value of a pixel in the line to be rendered and an illumination parameter corresponding to the image to be processed;
retrieve a corresponding drawing paint and a corresponding paint parameter according to the gray value and the illumination parameter; and
render a corresponding pixel based on the drawing paint and the paint parameter, and obtain the effect image.

29. The non-transitory computer-readable storage medium of claim 20, wherein the computer-executable instructions further cause the computer processor to:
determine, according to the image to be processed and a target contrast view, the brush model to be rendered.
